(19) United States
(12) Patent Application Publication
(10) Pub. No.: US 2009/0213268 A1
(43) Pub. Date: Aug. 27, 2009

(54) TELEVISION SET INTEGRATED WITH A COMPUTER

(76) Inventor: Kuo-Shun Huang, Tainan (TW)

Correspondence Address: STOUT, UXA, BUYAN & MULLINS LLP, 4 VENTURE, SUITE 300, IRVINE, CA, 92618, US

(21) Appl. No.: 12/038,048

(22) Filed: Feb. 27, 2008

(51) Int. Cl. H04N 7/00

(52) U.S. Cl. 348/552; 348/E07.091

(57) ABSTRACT

A television set integrated with a computer is disclosed. The television set includes a display, a video/audio control unit, and a computer mother unit. A portion or whole of the display, the video/audio control unit, and the computer mother unit are integrated to incorporate the power of the computer.

### BACKGROUND OF THE INVENTION

1. Field of the Invention

The present invention generally relates to a television set, and more particularly to a television set that incorporates the powerful capability of the modern computer.

2. Description of the Prior Art

Since the commercial availability from the late 1930s, television (TV) set has become a common household electronic device as a source of entertainment and news. Further, since 1970s, owing to the technology of video recording on VCR tapes and recently on optical compact discs, the usage of the television set is enhanced to be capable of viewing the recorded programs in concert with audio/video recorder.

On the other side of the technology development, particularly in the modern information age, personal computer has become a widespread electronic device that has powerful capability to perform complicated tasks of, for example, complex audio/video processing and application, and to communicate with other computers through the Internet.

Nevertheless, no trend has been taken to merge the popularity of the television set with the power of the computer. In other words, the television set, even a modern one, has not been employed to perform a complicated task as the computer does. While interactive television is lately devised to allow viewers to interact with television content as they view it, the interactive television still cannot catch up with the complexity and the power of the computer. Even it is possible to utilize the power of the computer with the television set by wiring between the television set and the computer, it is extremely cumbersome to handle because of the complex wiring and the total significant size or weight.

For the reason that conventional television set has limited and confined applicability, a need has arisen to propose a powerful television set that can sufficiently and fully utilize the powerful capability of the modern computer without substantially increasing the size and weight, thereby facilitating and enhancing the quality of life.

### SUMMARY OF THE INVENTION

In view of the foregoing, it is an object of the present invention to provide a powerful television set that integrate and incorporate the power of the computer to perform the functions of, for example, computer, communication, and control (or 3C), without substantially increasing the size and weight.

According to the object, the present invention provides a television set integrated with a computer. The television set includes a display, a video/audio control unit, and a computer mother unit. A portion or whole of the display, the video/audio control unit, and the computer mother unit are integrated to incorporate the power of the computer.

According to a specific embodiment of the present invention, the television set includes a flat panel display, a computer mother unit, and a video/audio control unit. The computer mother unit performs a task of a computer, and includes at least a central processing unit, an auxiliary chip, and a memory. The video/audio control unit includes a video/audio data stream controller for receiving video/audio data from the computer mother unit, and then converting the video/audio data into a serial bit stream. The flat panel display or the video/audio control unit includes a driver for converting the serial bit stream into analog signal suitable for driving the display.

### BRIEF DESCRIPTION OF THE DRAWINGS

FIG. 1 illustrates a television set that utilizes and integrates the powerful capability of the modern computer according to one embodiment of the present invention;

FIGS. 2A-2B illustrate a first configuration of the television set that integrates the display, the video/audio control board, and the computer mother board;

FIGS. 3A-3B illustrate a second configuration of the television set that integrates the video/audio control board and the computer mother board in a printed circuit board; and

FIGS. 4A-4B illustrate a third configuration of the television set in which the video/audio control board and the computer mother board are manufactured respectively in printed circuit boards.

### DETAILED DESCRIPTION OF THE INVENTION

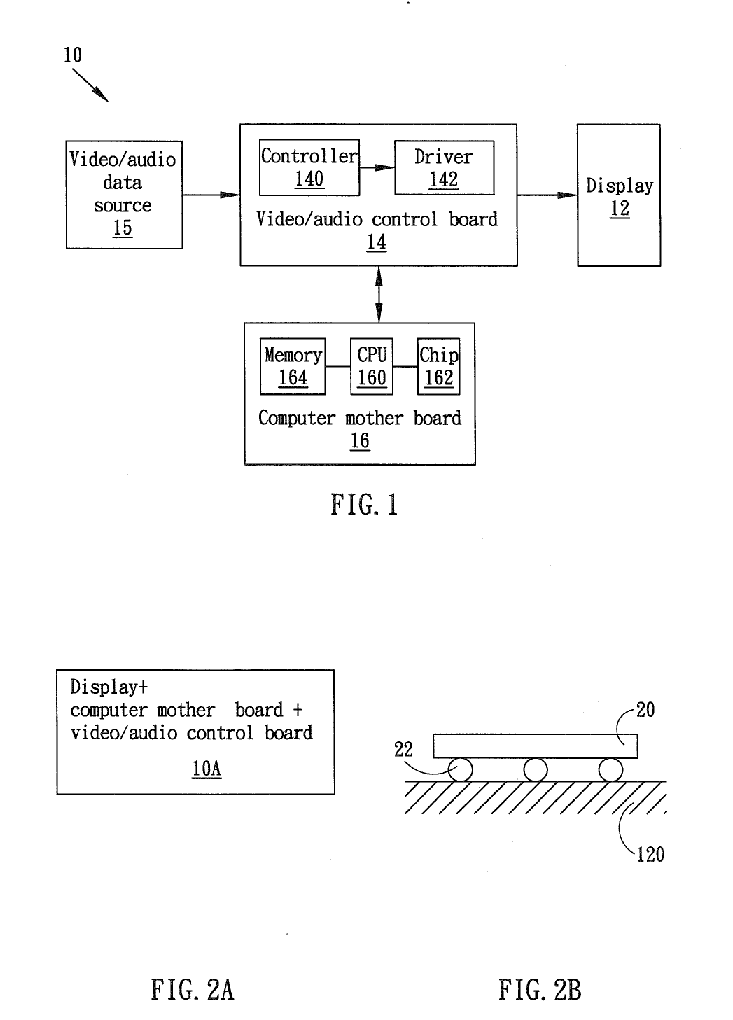

FIG. 1 illustrates a television set 10 that utilizes and integrates the powerful capability of the modern computer according to one embodiment of the present invention. In the embodiment, the television set 10 includes, but is not limited to, a display 12, a video/audio control board (or unit) 14, and a computer mother board (or unit) 16. In the embodiment, the display 12, the video/audio control board 14, and the computer mother board 16 are made in a single chassis (not shown).

The display 12 is preferably a flat panel display that is advantageously lighter and much thinner than traditional television set, such as cathode ray tube (CRT). The flat panel display 12 may be, but not limited to, a liquid crystal display (LCD) panel, a plasma display panel (PDP), or organic light-emitting diode (OLED) panel. Specifically, the LCD panel includes crystal molecules that are aligned according to the applied voltage, and are used to pass or block light source. The PDP panel includes cells located between two panels of glass holding inert mixture of noble gasses (such as neon and xenon), which is electrically turned on into a plasma and then excites phosphors to emit light. The OLED panel includes organic compound, such as polymer that can emit light of different colors.

The video/audio control board 14 may be, but not limited to, a video processor, audio processor, an amplifier, a panel driver, a timing controller (TCON), or/and an audio driver. In the embodiment, the video/audio control board 14 includes at least a video/audio data stream controller 140 and a driver 142. The video/audio data stream controller 140 may receive video/audio data from the computer mother board 16, and converts the data into a serial bit stream that represents (color) video/audio signal. Alternatively, the video/audio data stream controller 140 may receive video/audio data from an external video/audio data source 15. The external video/audio data source 15 may provide, for example, Composite Video Broadcast Signal (abbreviated CVBS), Separate-video (S-video) signal, Subminiature D connector (D-sub) signal, YPbPr component video signal, High Definition Multimedia Interface (abbreviated HDMI) signal, Digital Visual Interface (abbreviated DVI) signal, or Display Port signal. The CVBS signal is, for example, provided by an analog tuner or a digital tuner. The driver 142 may be located in the display 12, or may be located in the video/audio control board 14. The driver 142 is used to convert the serial bit stream (or the video/audio signal) into an appropriate analog signal suitable for driving the display 12. The video/audio data stream controller 140 and a driver 142 may together or individually configured to perform a specific task, for example, as being an image capture device, such as PC Cam, digital camera, or digital camcorder. In another example, the video/audio control board 14 may be configured to act as an LCD panel driver, a PDP panel driver, or an OLED panel driver. In a further example, the video/audio control board 14 may be configured to act as an audio retrieving device, such as a microphone; or as an audio outputting device, such as a speaker.

The computer mother board 16 may include circuits and functions of, for example, a general computer (such as a personal computer) or a specific computer. In the embodiment, the computer mother board 16 includes at least a central processing unit (CPU) 160, an auxiliary chip 162, and a memory 164. The auxiliary chip 162 may be the south/north bridge control chip, the Ethernet/Internet control chip, a hard disk controller, or/and a flash controller. The CPU 160, the auxiliary chip 162, and the memory 164 may together configured to perform a specific task, such as to be a scanner for retrieving images or text, or a printer for producing hard copy. In addition to the image/video processing, the computer mother board 16 may further perform other functions of, for example, computer, communication, or/and control (or 3C).

In an exemplified embodiment, the signals communicated between the display 12 and the video/audio control board 14 may use signaling system such as reduced swing differential signaling (RSDS) or low-voltage differential signaling (LVDS). The LVDS signaling system, in particular, can run at very high speeds over twisted-pair cables. The signals, primarily video/audio signals, communicated between the video/audio control board 14 and the computer mother board 16 may use telecommunication system such as analog television (ATV) or digital television (DTV) system. The DTV is for broadcasting and receiving moving pictures and sound by means of digital signals, in contrast to analog signals used in traditional ATV.

FIGS. 2A-2B illustrate a first configuration of the television set 10A that integrates the display 12, the video/audio control board 14, and the computer mother board 16. In the embodiment, the essential circuit or circuits of the display 12, the video/audio control board 14 and the computer mother board 16 are manufactured within a chip on glass (COG) 20 that is connected onto one panel of glass 120 of the display 12. For example, in FIG. 2B, the COG 20 is bounded onto the surface of the panel of glass 120 via bumps 22. In another embodiment, the essential circuit or circuits of the display 12, the video/audio control board 14 and the computer mother board 16 are manufactured within a few chips. In a further embodiment, the essential circuit or circuits of the display 12, the video/audio control board 14 and the computer mother board 16 are manufactured by multi-layer printed circuit board (PCB) that is connected onto one panel of glass 120 of the display 12.

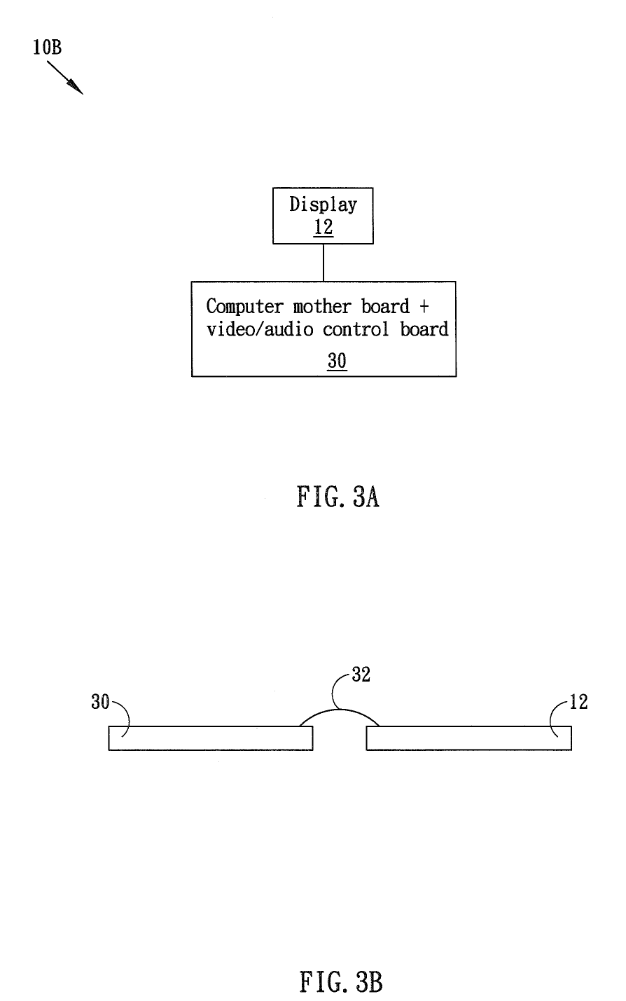

FIGS. 3A-3B illustrate a second configuration of the television set 10B that integrates the video/audio control board 14 and the computer mother board 16 in a printed circuit board (PCB) 30. In the embodiment, the video/audio control board 14 and the computer mother board 16 are manufactured within the PCB 30 that is then connected to the display 12. The PCB 30 may be a rigid printed circuit board or a flexible printed circuit board. For example, in FIG. 3B, the PCB 30 is electrically communicated to the display 12, for example, via cable or bus 32.

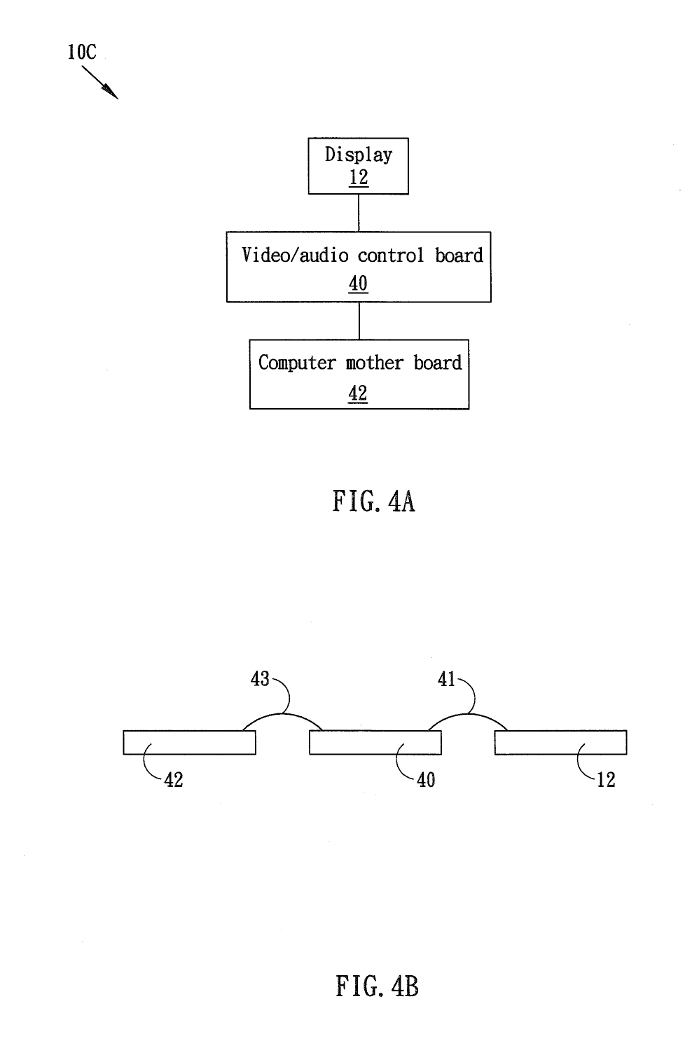

FIGS. 4A-4B illustrate a third configuration of the television set 10C in which the video/audio control board 14 and the computer mother board 16 are manufactured respectively in a first printed circuit board (PCB) (or control PCB) 40 and a second printed circuit board (PCB) (or computer PCB) 42. The PCB 40 or 42 may be a rigid printed circuit board or a flexible printed circuit board. The interconnection between the display 12 and the first PCB 40, and the interconnection between the first PCB 40 and the second PCB 42 may be cable or bus (such as address bus, data bus, or/and control bus) conforming to an interface protocol (such as IEEE 1394, USB, PCI, PCI express, or AMBA). The first PCB 40 is further connected to the display 12. For example, in FIG. 4B, the first PCB 40 is electrically communicated to the display 12 via cable/bus 41, and the second PCB 42 is electrically communicated to the first PCB 40 via cable/bus 43.

According to the embodiments described above, the present invention provides a powerful television set that integrates and incorporates the power of the computer to perform the functions of, for example, computer, communication, or/and control (or 3C), without substantially increasing the size and weight. The television set integrated with the computer can be used to further compute and analyze the video/audio content. For example, the television set according to the present invention may be used to process digital watermarking, which allows only legal image/picture to be displayed or recorded. For another example, the television set according to the present invention may be used to assess image quality, monitor the image, or perform related video DNA technique.

Although specific embodiments have been illustrated and described, it will be appreciated by those skilled in the art that various modifications may be made without departing from the scope of the present invention, which is intended to be limited solely by the appended claims.

What is claimed is:

1. A television set integrated with a computer, comprising:
a display;
a video/audio control unit for processing video/audio data and generating video/audio signal to the display; and
a computer mother unit that performs a task of a computer.

2. The television set according to claim 1, wherein the display comprises a flat panel display.

3. The television set according to claim 2, wherein the flat panel display is an LCD panel, a PDP panel, or an OLED panel.

4. The television set according to claim 1, wherein the video/audio control unit comprises:
a video/audio data stream controller for receiving the video/audio data from the computer mother unit or from an external video/audio data source, and then converting the video/audio data into a serial bit stream.

5. The television set according to claim 4, wherein the video/audio control unit further comprises:
a driver for converting the serial bit stream into analog signal suitable for driving the display.

6. The television set according to claim 4, wherein the display comprises:
a driver for converting the serial bit stream into analog signal suitable for driving the display.

7. The television set according to claim 1, wherein the video/audio control unit is configured to act as an image capture device.

8. The television set according to claim 7, wherein the image capture device is PC cam, digital camera, or digital camcorder.

9. The television set according to claim 1, wherein the video/audio control unit is configured to act as a display panel driver.

10. The television set according to claim 1, wherein the video/audio control unit is configured to act as an audio retrieving device or an audio outputting device.

11. The television set according to claim 10, wherein the audio retrieving device is a microphone, and the audio outputting device is a speaker.

12. The television set according to claim 1, wherein the video/audio control unit is a video processor, audio processor, an amplifier, a panel driver, a timing controller (TCON), or an audio driver.

13. The television set according to claim 1, wherein the computer mother unit comprises:
a central processing unit;
an auxiliary chip; and
a memory.

14. The television set according to claim 13, wherein the auxiliary chip is a south/north bridge control chip, an Ethernet/Internet control chip, a hard disk controller, or a flash controller.

15. The television set according to claim 1, wherein the computer mother unit is configured to act as a scanner or a printer.

16. The television set according to claim 1, wherein the video/audio control unit, the computer mother unit, and circuit of the display are integrated in a single circuit that is connected to the display.

17. The television set according to claim 14, wherein the integrated single circuit is a chip on glass (COG) that is connected onto one panel of glass of the display.

18. The television set according to claim 1, wherein the video/audio control unit and the computer mother unit are integrated in a single circuit module that is electrically communicated to the display.

19. The television set according to claim 18, wherein the integrated single circuit module is a printed circuit board that is electrically communicated to the display via cable or bus.

20. The television set according to claim 1, wherein the video/audio control unit and the computer mother unit are respectively integrated in a first circuit module and a second circuit module.

21. The television set according to claim 18, wherein the first circuit module and the second circuit module are a first printed circuit board and a second printed circuit board respectively, wherein the first printed circuit board is connected to the display via a first cable or bus, and the second printed circuit board is connected to the first printed circuit board via a second cable or bus.

22. A television set integrated with a computer, comprising:
a flat panel display;
a computer mother unit that performs a task of a computer, comprising:
a central processing unit;
an auxiliary chip; and
a memory;
a video/audio control unit comprising:
a video/audio data stream controller for receiving video/audio data from the computer mother unit or from an external video/audio data source, and then converting the video/audio data into a serial bit stream; and
a driver for converting the serial bit stream into analog signal suitable for driving the display.

23. The television set according to claim 22, wherein the video/audio control unit, the computer mother unit, and circuit of the display are integrated in a chip on glass (COG) that is connected onto one panel of glass of the display.

24. The television set according to claim 22, wherein the video/audio control unit and the computer mother unit are integrated in a single printed circuit board that is electrically communicated to the display via cable or bus.

25. The television set according to claim 22, wherein the video/audio control unit and the computer mother unit are respectively integrated in a first printed circuit board and a second printed circuit board, wherein the first printed circuit board is connected to the display via a first cable or bus, and the second printed circuit board is connected to the first printed circuit board via a second cable or bus.
